(19) United States
(12) Patent Application Publication
(10) Pub. No.: US 2004/0038656 A1
(43) Pub. Date: Feb. 26, 2004

(54) Method and apparatus for distortion reduction and optimizing current consumption via adjusting amplifier linearity

(76) Inventors: John H. McCall, San Diego, CA (US); Richard K. Kornfeld, LaJolla, CA (US); Ana L. Welland, Rancho Santa Fe, CA (US)

Correspondence Address: TEXAS INSTRUMENTS INCORPORATED, P O BOX 655474, M/S 3999, DALLAS, TX, 75265

(21) Appl. No.: 10/440,814

(22) Filed: May 19, 2003

Related U.S. Application Data
(60) Provisional application No. 60/405,188, filed on Aug. 22, 2002.

(51) Int. Cl. H04B 7/00; H04B 1/06

(52) U.S. Cl. 455/138; 455/136

(57) ABSTRACT

System and method for reducing distortion in a receiver by adjusting amplifier linearity. A preferred embodiment comprises measuring a received signal's power level and then making an adjustment the linearity of a receiver's amplifier, wherein the amplifier lies within the receiver chain. A second measurement of the received signal power level is made, followed by a calculation of the difference of the signal power levels. If the difference is less than expected, distortion is insignificant and linearity should be reduced to reduce power consumption. If the difference is greater than expected, then distortion is significant and the amplifier's linearity should be increased to reduce distortion. These measurements can be repeated to find an optimal operating point to minimize distortion and power consumption.

This application claims the benefit of U.S. Provisional Application No. 60/405,188, filed on Aug. 22, 2002, entitled “Method and Apparatus for Dynamically Detecting Distortion in a Receiver and Optimizing Current Consumption by Adjusting Linearity”, which application is hereby incorporated herein by reference.

### TECHNICAL FIELD

The present invention relates generally to a system and method for wireless communications, and more particularly to a system and method for reducing distortion and power consumption in a wireless receiver.

### BACKGROUND

Distortion in a receiver used in a wireless communications network may have several causes, including in-band noise and interference, out-of-band noise and interference, inter-modulation (intermod), and cross modulation. Noise and interference (both in-band and out-of-band) may be the result of noise sources (such as electronic and electrical devices operating in the vicinity of the receiver, other wireless communications systems, and so forth). Intermod occurs when interfering signals are present at the receiver's input and are at certain frequency offsets from each other. The interferers fall into the receiver's desired signal band during processing (such as filtering and sampling). Cross modulation may be due to the full duplex operation of the receiver, wherein the transceiver's transmit signal modulates a nearby single (or multiple) tone interferer and the interferer ends up in the receiver's desired signal band.

Regardless of the original cause of the distortion, distortion may hurt the performance of the receiver by raising the overall noise floor of the receiver and decreases the signal-to-noise ratio. The increased noise floor and decreased signal-to-noise ratio reduces the overall performance (call quality, data transfer rate, and so forth) of the communications system. If the distortion is strong enough, it is possible for wireless communications device to stop operating altogether.

As an example, take a code-division multiple access (CDMA) wireless communications device that is operating in the vicinity of other wireless communications devices such as AMPS (advanced mobile phone system) and TDMA (time-division multiple access) communications devices. To provide adequate coverage, the communications system providers will place cell sites throughout the coverage area. This means that these systems will cohabitate. This can result in signals from one communications system being received by another system's communication device, AMPS signals received by the CDMA communications device, for example. The AMPS signals may then become a source of distortion for the CDMA communications device via one or more of the distortion types discussed previously (in-band and out-of-band, intermod, and cross modulation).

A proposed solution for reducing distortion involves adjusting the gain in the receiver's front end and measuring the resulting change in the receiver's intermediate frequency (IF) section. If the resulting signal power change is below a predetermined amount, then signal (both the desired signal and the interferers) are below the noise floor and the gain is increased. If the resulting signal power change is equal to the predetermined amount, then the signal is above the noise floor and the interference is minimal. Finally, if the resulting signal power change is greater than the predetermined amount, then significant interference is present and the gain is reduced to reduce the interference.

One disadvantage of the prior art is that by adjusting the signal gain, the actual amplitude of the signal changes. This may lead to loss of resolution at a later point in the receiver, for example, the receiver's analog-to-digital converter would necessarily need to have greater dynamic range (more expensive) or some of the converter's resolution will be lost (decreased performance).

A second disadvantage of the prior art is that if the signal is amplified significantly, the variable amplifier's own dynamic range may not be able to support the full range of the signal. Therefore, a more expensive variable amplifier with greater dynamic range is needed or signal clipping may have to be accepted. A more expensive variable amplifier could lead to a more expensive receiver and communications device.

### SUMMARY OF THE INVENTION

These and other problems are generally solved or circumvented, and technical advantages are generally achieved, by preferred embodiments of the present invention which provides a system and method for reducing distortion and minimizing power consumption in a wireless receiver by changing the linearity of amplifiers in the wireless receiver.

In accordance with a preferred embodiment of the present invention, a method for reducing distortion comprising determining if distortion is present in a received signal, increasing amplifier linearity if distortion is present, and decreasing amplifier linearity if distortion is absent.

In accordance with another preferred embodiment of the present invention, a circuit comprising an automatic gain control (AGC) unit coupled to a digital data stream, the AGC containing circuitry to measure a power level of a signal carried in the digital data stream and to produce an amplifier gain compensation value, and a distortion detection and compensation (DDC) unit coupled to the AGC, the DDC containing circuitry to determine the amount of distortion in the signal carried in the digital data stream and to produce a bias voltage compensation value.

In accordance with another preferred embodiment of the present invention, a wireless receiver comprising a receiver chain coupled to a signal input, the receiver chain containing circuitry to amplify, filter, mix, and digitally convert a signal on the signal input, an automatic gain control (AGC) unit coupled to the receiver chain, the AGC containing circuitry to measure a power level of the signal carried on a digital data stream produced by the receiver chain and to produce an amplifier gain compensation value, and a distortion detection and compensation (DDC) unit coupled to the AGC, the DDC containing circuitry to determine the amount of distortion in the signal carried in the digital data stream and to produce a bias voltage compensation value.

An advantage of a preferred embodiment of the present invention is that sensitivity is not degraded when adjusting the linearity of the wireless device's amplifier. This is due to the fact that neither the amplifier's noise figure nor the desired signal gain of the device is changed significantly when the linearity is adjusted.

A further advantage of a preferred embodiment of the present invention is that by not amplifying the signal being received, amplifiers with smaller dynamic range can be used. These amplifiers tend to be less expensive than amplifiers with greater dynamic range. Hence the overall cost of the wireless receiver may be reduced.

Yet another advantage of a preferred embodiment of the present invention is that the overall power consumption can be reduced by continually adjusting the linearity of the amplifiers to minimize distortion. This has an added benefit of using as little power as possible and still maintaining a specified level of distortion because an amplifier's linearity can have a significant impact on its power consumption. By reducing power usage, the wireless receiver consumes less power and thereby increasing the wireless receiver's battery life (should the device happen to be battery powered).

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 is a diagram of a typical operating environment for a wireless device;

FIG. 2 is a data plot of bias voltage versus amplifier linearity;

FIG. 3 is a flow diagram of an algorithm for adjusting the linearity of an amplifier to reduce distortion, according to a preferred embodiment of the present invention;

FIG. 4 is a flow diagram of an algorithm for decreasing distortion by increasing an amplifier's linearity, according to a preferred embodiment of the present invention;

FIG. 5 is a flow diagram of an algorithm for decreasing power consumption by decreasing an amplifier's linearity, according to a preferred embodiment of the present invention;

FIG. 6 is a diagram of a wireless receiver with support for distortion reduction and optimized current consumption by adjusting amplifier linearity, according to a preferred embodiment of the present invention;

FIG. 7 is a diagram of a wireless receiver's receiver chain, according to a preferred embodiment of the present invention;

FIG. 8 is a diagram of a wireless receiver's automatic gain control (AGC) unit, according to a preferred embodiment of the present invention;

FIG. 9 is a diagram of a wireless receiver's distortion detection and compensation (DDC) unit, according to a preferred embodiment of the present invention;

FIG. 10 is a data plot of in-band output signal level with intermod products versus amplifier linearity, according to a preferred embodiment of the present invention; and

FIG. 11 is a data plot of amplifier gain versus bias voltage (linearity), according to a preferred embodiment of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely a wireless receiver (a mobile station) for use in a code-division multiple access (CDMA) wireless communications network. The invention may also be applied, however, to other wireless communications network and to wireless receivers present in both a mobile station and in a base station.

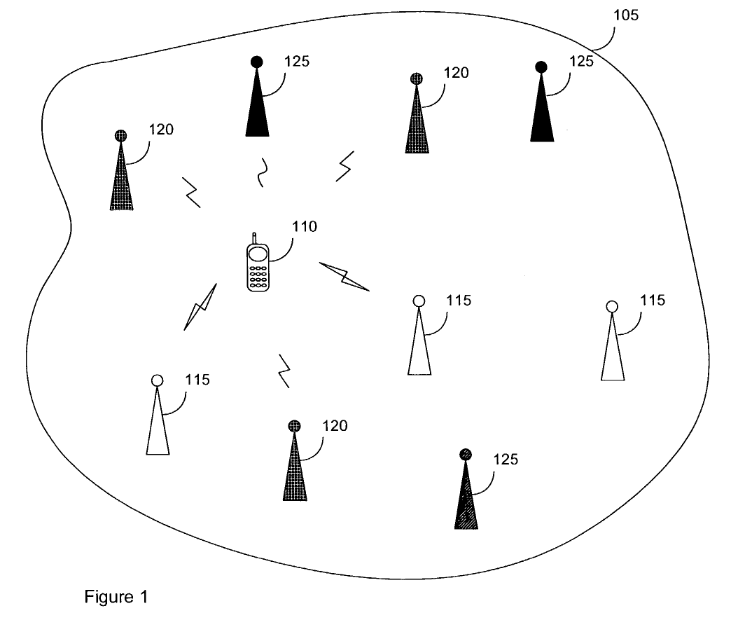

With reference now to FIG. 1, there is shown diagram illustrating a typical operating environment for a wireless device 110 wherein the wireless device 110 is a member of a particular type of wireless communications network, but in an environment where other types of wireless communications networks are also being used. As displayed in FIG. 1, the wireless device 110 is part of a wireless communications network (for example, a code division multiple access (CDMA) network) and communicates with base stations (for example, base stations 115) which are also members of the same wireless communications network. However, base stations (for example, base stations 120 and 125) from other wireless communications networks (for example, advanced mobile phone system (AMPS) and time division multiple access (TDMA) networks) are also operating in the near vicinity. Signals (transmissions) from these other wireless communications networks may be received by the wireless device 110.

While a significant percentage of the transmissions from these other wireless communications network are rejected by built-in countermeasures in the wireless device 110 such as filters, some of the transmissions may be able to by-pass these countermeasures and be combined with the transmissions intended with the wireless device 110. The transmissions from the other wireless communications network may distort the signal intended for the wireless device 110 and hence possibly reduce the performance of the wireless device 110 in terms of reduced data rate, reduced call quality, and so forth.

Transmissions from the other wireless communications networks operating in the general vicinity along with other sources of interference (such as electrical motors, electronic equipment, and so forth) may be received by the wireless device 110 and present themselves as distortion in the received signal. There may be several different types of distortion scenarios, including in-band and out-of-band interferers, intermodulation, and cross modulation.

Distortion in the received signal typically does not behave in a manner that is consistent with the received signal when the received signal undergoes amplification or when the linearity of an amplifier used to amplify the received signal is adjusted. This may be due to the fact that the distortion is normally not within the band of the received signal, but is modulated down (or up) into the band of the received signal during processing of the received signal.

In fact, the difference in the behavior of the distortion and the received signal can be exploited to detect and then reduce the distortion. In general, an adjustment is made to the linearity (also referred to as adjusting the bias voltage) or the amplification of the amplifier and the resulting change in the output is measured. The amount of change may be used to determine the amount of distortion in the signal. For example, if the amount of change is less than expected, then the distortion is negligible and the bias voltage can be further reduced and if the amount of change is greater than expected, then the distortion is significant and the bias voltage should be increased.

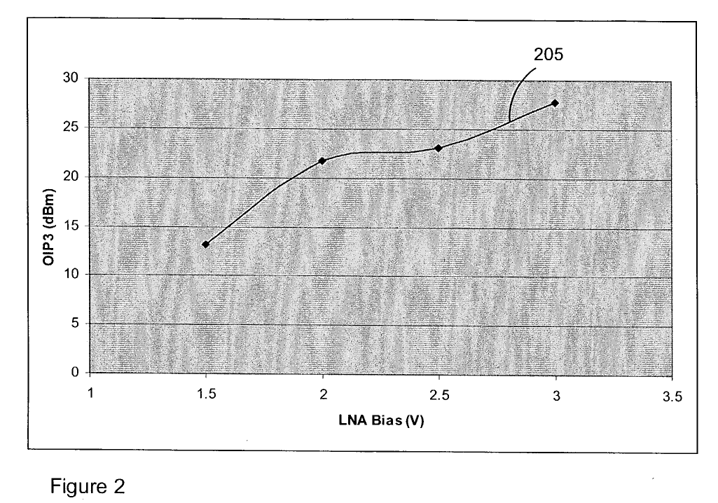

With reference now to FIG. 2, there is shown a diagram illustrating a data plot of a bias voltage of a low-noise amplifier (LNA) versus the LNA's output third order intermodulation (IMD) intercept point and intermodulation distortion product levels (OIP3). Wherein OIP3 is a measure of amplifier linearity. The plot shows that with a bias voltage change of approximately 1.5 volts (from 1.5 volts to 3.0 volts), a resulting change in the LNA's OIP3 levels of over 20 decibels (dB) is seen. Clearly, the bias voltage can have significant effect on the LNA's linearity.

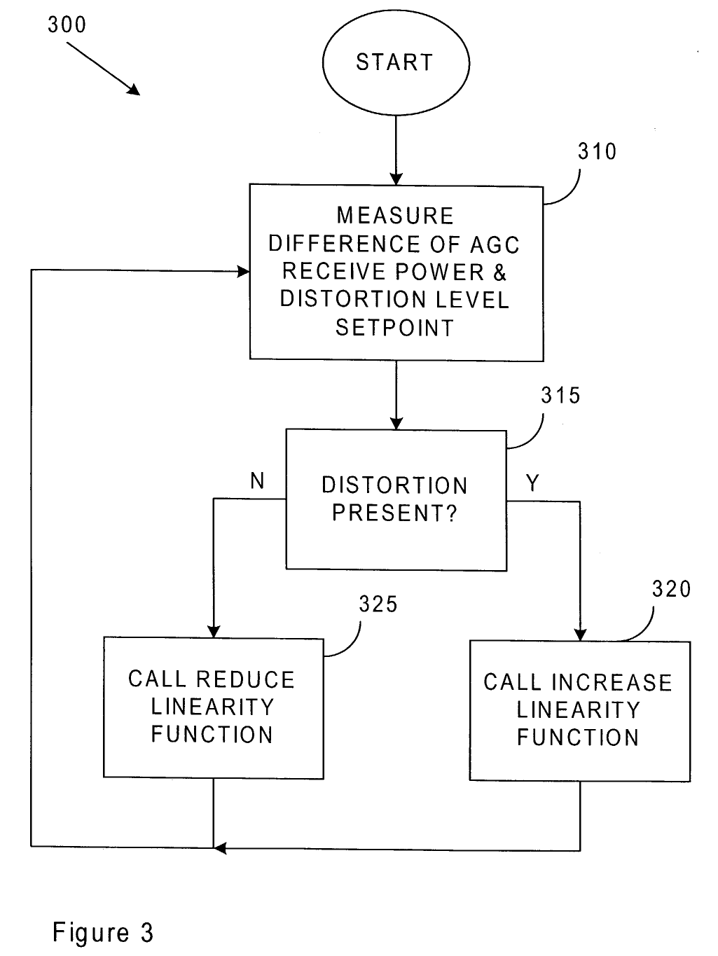

With reference now to FIG. 3, there is shown a diagram illustrating an algorithm 300 for adjusting the linearity of a wireless device's LNA to reduce distortion, according to a preferred embodiment of the present invention. According to a preferred embodiment of the present invention, the algorithm 300 may on a processor (not shown) that may be responsible for the operation of a wireless device. Alternatively, the algorithm 300 may execute on a microcontroller, a digital signal processor, a custom designed application specific integrated circuit (ASIC), or so forth. The algorithm 300 may be configured to be running continuously in the background or it may be set to execute one time per specified period of time. Alternatively, the algorithm 300 may execute when a performance metric (measured by the wireless device or by its base station) exceeds a predetermined value. Examples of possible performance metrics may include bit error rate (BER), frame error rate (FER), packet error rate (PER), received signal strength, and so on.

The processor may begin execution of the algorithm after the wireless device's automatic gain control (AGC) loop has stabilized and a desired signal level is reached. First, the processor measures a difference between the AGC's received power and a distortion level set point (block 310). The AGC received power may be a measurement of the power in the received signal (including any distortion) after the wireless device's AGC has stabilized while the distortion level set point is a specified amount of distortion and may be used as a metric to determine a course of action. For example, if the measured difference exceeds a specified value, then the processor may determine that enough distortion is present in the received signal so that corrective action should be taken.

After measuring the difference (block 310), the processor may then determine if distortion is present in the received signal (block 315). Alternatively, the processor may be determining if there is a sufficient amount of distortion present in the received signal, since it may be difficult to have a received signal without any distortion. Should the processor determine that there is distortion (or a sufficient level of distortion) present in the received signal, the processor may then execute an increase linearity function (block 320). If there is no distortion (or there is an insufficient level of distortion) present in the received signal, the processor may then execute a reduce linearity function (block 325). The two linearity adjustment functions will be discussed in greater detail below. After whichever linearity adjustment function executed by the processor completes, the processor may return to block 310 to continue monitoring the quality of the received signal. Note that the processor may permit the expiration of a specified amount of time prior to returning to block 310 or the processor may wait for a specified performance metric to exceed a specified value prior to returning to block 310.

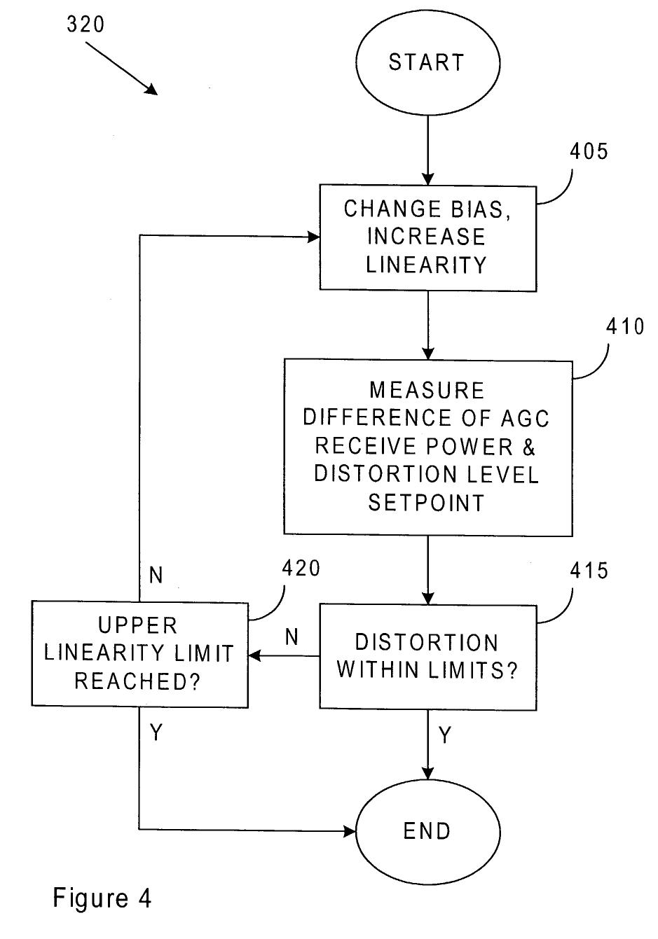

With reference now to FIG. 4, there is shown a diagram illustrating an algorithm for decreasing distortion by increasing an amplifier's linearity, according to a preferred embodiment of the present invention. According to a preferred embodiment of the present invention, the algorithm illustrated in FIG. 4 may be an implementation of an increase linearity function executed by a processor as illustrated in block 320 of FIG. 3.

The processor may begin by changing the amplifier's bias voltage to increase the amplifier's linearity (block 405) and then the processor can measure a difference between the wireless device's AGC received signal power and a specified distortion level set point (block 410). Note that in between block 405 (adjusting linearity) and block 410 (measuring the difference), the processor should permit the AGC sufficient time to stabilize to the new bias voltage setting.

The processor may then determine if the distortion in the received signal is within specified limits (block 415). For example, if the difference measured in block 410 is greater than expected, then the distortion is significant and the bias voltage (and hence the amplifier's linearity) should be increased to further reduce the distortion. If the distortion is not within acceptable limits, the processor may check to see if the amplifier has reached its upper linearity limit (block 420), i.e., the linearity of the amplifier can no longer be increased. If the amplifier has not reached its linearity limits, the processor may return to block 405 to further increase the linearity of the amplifier. If the amplifier has reached its linearity limit (block 420) or if the distortion is within acceptable limits (block 415), then the increase linearity function completes.

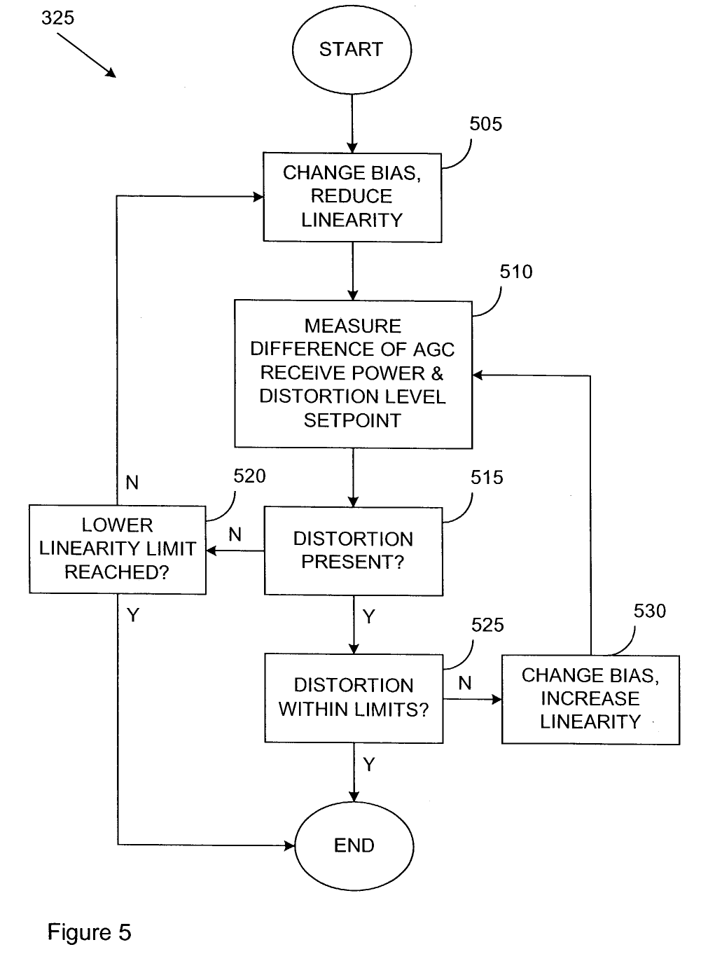

With reference now to FIG. 5, there is shown a diagram illustrating an algorithm for decreasing power consumption by decreasing an amplifier's linearity, according to a preferred embodiment of the present invention. According to a preferred embodiment of the present invention, the algorithm illustrated in FIG. 5 may be an implementation of a decrease linearity function executed by a processor as illustrated in block 325 of FIG. 3. According to a preferred embodiment of the present invention, the algorithm illustrated in FIG. 5 may be an implementation of a decrease linearity function executed by a process as illustrated in block 325 of FIG. 3.

The processor may begin by changing the amplifier's bias voltage to decrease the amplifier's linearity (block 505) and then the processor can measure a difference between the wireless device's AGC received signal power and a specified distortion level set point (block 510). Note that again, the processor should permit the AGC sufficient time to stabilize to the new bias voltage setting, perhaps by waiting for a period of time between blocks 505, adjusting the linearity, and 510, measuring the difference.

The processor may then determine if there is distortion in the received signal (block 515). Note that it is likely that there will be some form of distortion, however, if the distortion is below a specified threshold, then it may be said that there is no distortion in the received signal. If no distortion is present, then the processor may then check to see if the amplifier has reached a lower limit on its linearity adjustment (block 520), i.e., the linearity of the amplifier may no longer be decreased.

If the amplifier's lower linearity limit has not been reached, then the processor may choose to return to block 505 to further lower the amplifier's linearity. If the amplifier's lower linearity limit has been reached, then the reduce linearity function can terminate.

If there is distortion present (block 515), then the processor may then check to see if the distortion is within specified limits (block 525). If the distortion is within specified limits, then the reduce linearity function can terminate. If distortion is present (block 515) and exceeds a specified limit (block 525), then the processor may choose to increase the amplifier's linearity to reduce the distortion (block 530). After the processor increases the amplifier's linearity, the processor returns to block 5150 to recalculate a difference between the AGC received power and the distortion level set point.

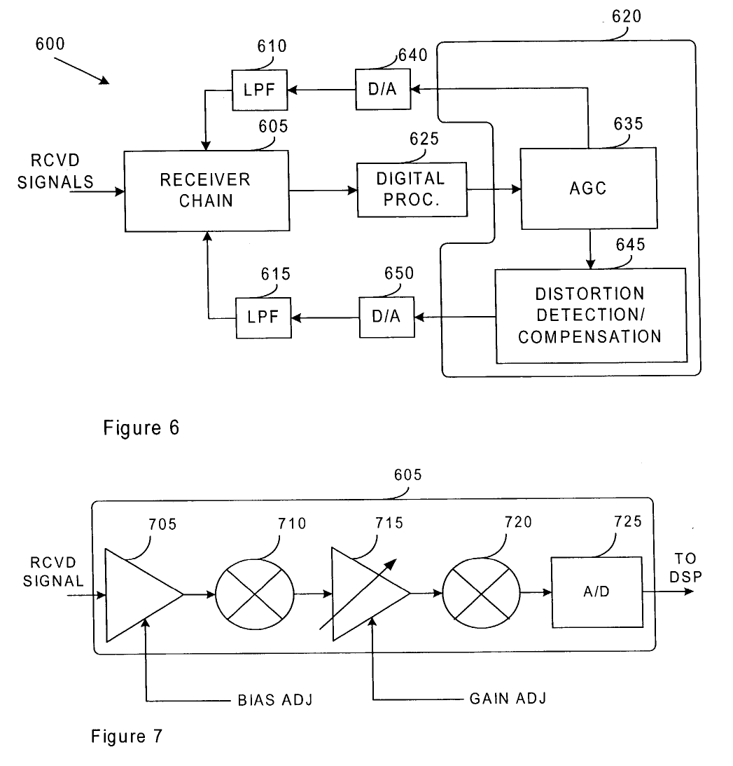

With reference now to FIG. 6, there is shown a diagram illustrating a block diagram of a wireless receiver 600 with support for distortion reduction and optimized current consumption by adjusting amplifier linearity, according to a preferred embodiment of the present invention. The wireless receiver 600 includes a receiver chain 605 and an automatic gain control (AGC) and receive power management unit (AGCRPM) 620. The receiver chain 605 may be mainly responsible for analog signal processing of signals received by the wireless receiver 600, including but not limited to signal amplification (and perhaps attenuation), filtering, modulation, and analog-to-digital conversion. The AGCRPM 620 may be responsible for such functions as automatic gain control and distortion detection and compensation. Note that the AGCRPM 620 may be implemented as hardware or as firmware and software subroutines executing on a processing element (or digital signal processor) located in the wireless receiver 600.

With reference now to FIG. 7, there is shown a diagram illustrating a detailed view of a receiver chain for a wireless receiver, according to a preferred embodiment of the present invention. According to a preferred embodiment of the present invention, the receiver chain as displayed in FIG. 7 may be an implementation of the receiver chain 605 as illustrated in FIG. 6. The receiver chain 605 may have, as its input, a received signal which may have been transmitted over-the-air and received by an antenna (not shown). The received signal may then be provided to an amplifier 705 that may be used to provide sufficient amplification to the received signal in order to bring it to proper signal levels for processing within the wireless receiver. The amplifier 705 may feature an adjustable bias level that may be controlled by a bias adjust signal that may be provided from other circuitry further in the wireless device. After amplification, the received signal may be down converted to an intermediate frequency by a mixer 710.

The down converted signal may then be amplified a second time by a variable gain amplifier (VGA) 715. The VGA 715 may be different from the amplifier 705 in that it may have a narrower operational bandwidth, but perhaps with a lower noise figure and so forth. The signal may undergo an additional stage of down conversion by a second mixer 720, perhaps to bring the signal to its baseband frequency. Finally, the baseband signal can be converted into digital data by an analog-to-digital converter (ADC) 725.

With reference back to FIG. 6, after being converted from an analog signal into a digital data stream by the ADC 725, the digital data stream may then undergo digital signal processing 625. According to a preferred embodiment of the present invention, the digital signal processing 625 may be performed on a dedicated digital signal processing unit, a generic digital signal processing unit, a general purpose processor, a custom designed application specific integrated circuit (ASIC), or so on. The digital signal processing 625 may include tasks such as decoding, digital filtering, noise shaping, error detecting and correcting, and so forth on the digital data stream.

The received signal (in the form of a digital data stream) may then be provided to an automatic gain control unit (AGC) 635 of the AGCRPM 620. The AGC 635 may be responsible for functions such as noncoherent (and perhaps coherent) accumulation, integration and dump, received signal gain compensation, and so on. A critical function of the AGC 635 may be to ensure that the received signal is at an ideal signal power so that it may be efficiently processed. As stated previously, the AGC 635 may be implemented in hardware or firmware and software executing on a processing element or a digital signal processor.

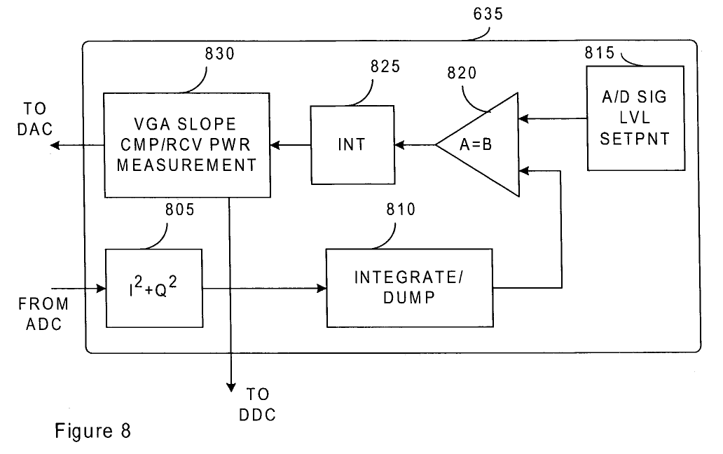

With reference now to FIG. 8, there is shown a diagram illustrating a detailed view of an automatic gain control unit (AGC) for a wireless receiver, according to a preferred embodiment of the present invention. According to a preferred embodiment of the present invention, the AGC displayed in FIG. 8 may be an implementation of the AGC 635 as displayed in FIG. 6. The AGC 635 may take, as an input, the digital data stream from the receiver chain 605 (FIG. 6). The digital data stream may then undergo noncoherent accumulation in a noncoherent accumulator 805. For example, in a CDMA wireless communications system, a signal is transmitted over two subchannels, an I subchannel and a Q subchannel. Noncoherent accumulation is accumulation that takes into account only the amplitude (or magnitude) of the signal on the two subchannels and not the phase of the signal. Noncoherent accumulation is a concept that is well understood by those of ordinary skill in the art of the present invention.

After noncoherent accumulation, the results of the noncoherent accumulation may then be provided to an integrate and dump unit 810. The integrate and dump unit 810 performs a summation of the noncoherent accumulation results (for a specified amount of time or accumulation results) and dumps the summation result to a comparator 820. The net effect of the noncoherent accumulator 805 and the integrate and dump circuit 810 may then be described as to provide a measure of the power in the I and the Q subchannels of the received signal.

The comparator 820 compares the result of the integrate and dump circuit 810 (the power of the received signal) with a signal level set point. According to a preferred embodiment of the present invention, the signal level set point may be stored in a memory location or register. In FIG. 8, the signal level set point is illustrated as being stored in a memory 815 which is labeled “Signal Level Set Point.” The comparator 820 may be a two value comparator and of the type that produces a first output value if the first of the two values is greater, a second output value if the second of the two values is greater, and a third output value if the two values are equal (or approximately). For example, the comparator 820 may produce a “+1” if the first of the two values is greater, a “−1” if the second of the two values is greater, and a “0” if the two values are equal.

The output of the comparator 820 may be provided to an integrator 825. The integrator 825 may be used to provide a “running sum” of the output of the comparator 820. For example, if the first of the two values is continually greater than the second, then the output of the comparator 820 will be “+1” for a majority of the time. The integrator 825 would then produce a large positive value. The same would be true (but with opposite sign) if the second value is continually greater than the first. The integrator's output may then be used to provide a compensation value that can be used to adjust the signal gain on a variable gain amplifier, such as the VGA 715 (FIG. 7). The output of the integrator 820 may be stored in a memory or a register for later use. In FIG. 8, the output of the integrator 820 is illustrated as being stored in a memory 830 which is labeled “VGA Slope Compensation and Receive Power Measurement.”

With reference back to FIG. 6, the output of the integrator 825 (FIG. 8), the VGA slope compensation and receive power measurement, may be used to adjust the signal gain in a variable gain amplifier that may be located in the receiver chain 605. According to a preferred embodiment of the present invention, if the received power measurement is greater than a predetermined value, the signal gain of the variable gain amplifier (for example, VGA 715 (FIG. 7)) may be reduced. The output of the integrator may require conversion back into an analog signal (by a digital-to-analog converter 640) prior to use in adjusting the signal gain of the VGA 715. Additionally, filtering (as provided by a low-pass filter (LPF) 610) may also be used to help eliminate some of the high-frequency transients that may be present in the compensation signals as provided by the integrator.

The output of the integrator may also be used to measure and compensate for distortion that may be present in the received signal. The output of the integrator may be provided to a distortion detection and compensation unit (DDC) 645. The DDC 645 may be responsible for detecting the presence of distortion in the received signal (if any) and if there is distortion present in the received signal, eliminate as much of it as possible.

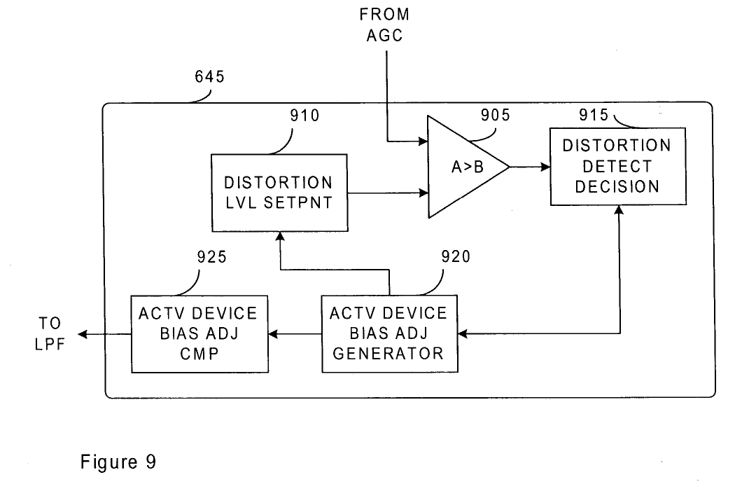

With reference now to FIG. 9, there is shown a diagram illustrating a detailed view of a distortion detection and compensation unit (DDC) for a wireless receiver, according to a preferred embodiment of the present invention. According to a preferred embodiment of the present invention, the DDC displayed in FIG. 9 may be an implementation of the DDC 645 as displayed in FIG. 6. As in the AGC 635 discussed above, the DDC 645 may be implemented as hardware or as firmware and software executing on a processing element or a digital signal processor located in the wireless receiver.

The DDC 645 may have, as an input, the received power measurement from the AGC 635 (FIG. 6). The received power measurement, as provided by the AGC 635, may be provided to a comparator 905, which may be configured to compare the received power measurement with a distortion level set point (possibly maintained in a memory 910 labeled “Distortion level set point.”

According to a preferred embodiment of the present invention, the comparator 905 checks to see if the received power measurement is greater than the distortion level set point. If the received power measurement is greater, then the comparator 905 may produce a certain output (perhaps a Boolean value) and if the received power measurement is smaller or equal to the distortion level set point, then the comparator 905 may produce a different output. Alternatively, the comparator 905 may produce a value that is proportional to the amount of difference between the received power measurement and the distortion level set point.

The output of the comparator 905 may then be provided to a distortion detect decision unit 915. The distortion detect decision unit 915 can make use of the information provided by the comparator 905 to determine if there is distortion in the received signal. According to a preferred embodiment of the present invention, the distortion detect decision unit 915 may implement linearity adjusting algorithms, such as those illustrated in FIGS. 3, 4, and 5 above.

Coupled to the distortion detect decision unit 915 is an active device bias adjust generator 920. The active device bias adjust generator 920 may be used to determine if linearity adjustments may be made to an amplifier, such as amplifier 705 (FIG. 7), and if linearity adjustments can be made, the active device bias adjust generator 920 can take adjustment commands from the distortion detect decision unit 915 and create appropriate linearity compensation signals that can be provided to the amplifier. The compensation signals created by the active device bias adjust generator 920 may be stored in a memory 925 (or a register) which is labeled “Active device bias adjust compensation.” The active device bias adjust generator 920 may also be coupled to the memory 910 storing the distortion level set point and through this coupling, it can make a change to the value of the set point.

According to a preferred embodiment of the present invention, since the operating environment in which a wireless receiver is operating can change dynamically, the DDC 645 may be configured to run continuously during normal operation of the wireless receiver so that the bias voltage on the amplifier can be adjusted to minimize both distortion and power consumption. Alternatively, the DDC 645 may be configured to operate intermittently, for example, after the expiration of a specified time period. Intermittent operation may further reduce power consumption and increase battery life. In yet another alternative preferred embodiment of the present invention, the DDC 645 may be configured to operate only when certain performance metrics exceed a specified level. For example, if a bit error rate (BER) exceeds a specified level, the DDC 645 may be turned on to eliminate distortion in the received signal. Other performance metrics may include frame error rate (FER), packet error rate (PER), received signal strength, and so forth.

With reference back to FIG. 6, the output of the active device bias adjust generator 920 (as stored in the memory 925) (both from FIG. 9) may be used to adjust the bias voltage of an amplifier, such as the amplifier 705 (FIG. 7). The output of the active device bias adjust generator 920 (FIG. 9) may require conversion back into an analog signal via a digital-to-analog converter 650 and filtering by a LPF 615 to possibly eliminate high-frequency transients.

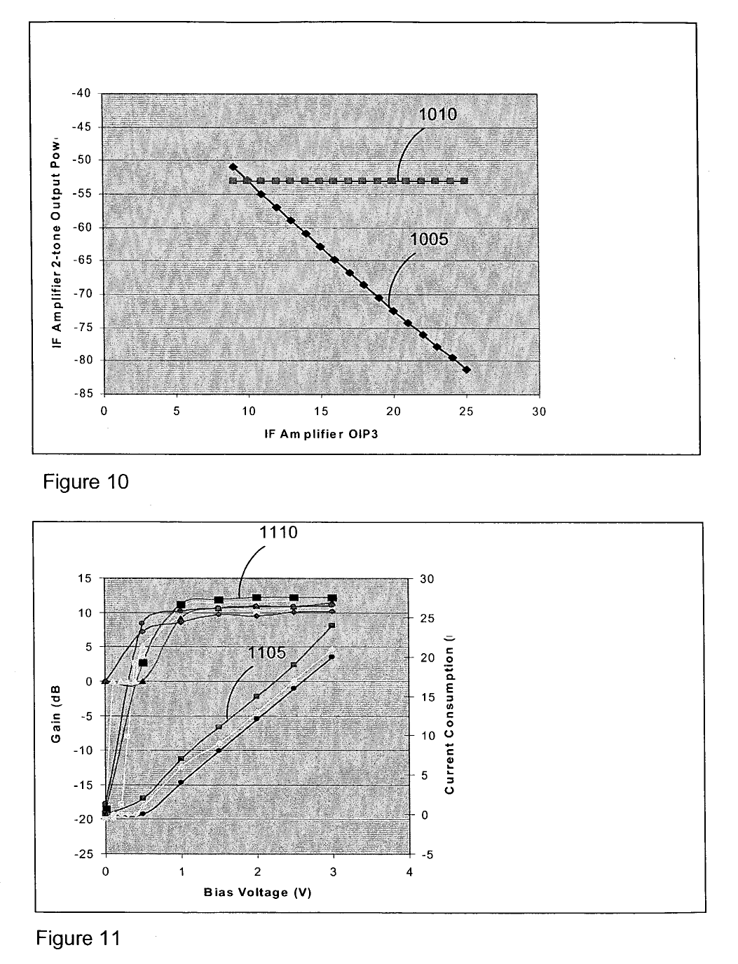

With reference now to FIG. 10, there is shown a data plot illustrating in-band output signal level 1005 and IMD products 1010 for an amplifier versus the amplifier's linearity (OIP3), according to a preferred embodiment of the present invention. The chart shows that the detected power can be dominated by intermodulation products at amplifier OIP3 (amplifier linearity) levels lower than 10 dBm (intersection of the in-band output signal level 1005 and the IMD products 1010). This results in an ability to detect these intermodulation products. For amplifier OIP3 levels above 10 dBm, intermodulation products are not readily detectable since they can be significantly smaller than the in-band output signal levels. This data plot shows that for certain levels of amplifier linearity, it may be easy to detect intermodulation products.

With reference now to FIG. 11, there is shown a data plot illustrating amplifier gain versus bias voltage, according to a preferred embodiment of the present invention. A first set of curves (curves 1105) illustrate amplifier current consumption and a second set of curves (curves 1110) illustrate amplifier gain. The data plot shows that when the bias voltage is in the one (1) volt to three (3) volt range, amplifier current consumption can vary dramatically while amplifier gain may remain relatively constant. Therefore, as the bias voltage is adjusted to minimize distortion, the current consumption can also be adjusted with minimal effect upon the magnitude of the received signal. With minimal changes to the received signal, problems resulting from overly large or small signals, such as analog-to-digital converter resolution, clipping, and so forth can be alleviated.

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for reducing distortion comprising:
determining if distortion is present in a received signal;
increasing an amplifier's amplifier linearity if distortion is present; and
decreasing the amplifier's amplifier linearity if distortion is absent.

2. The method of claim 1, wherein the determining comprises:
measuring a power level in the received signal;
calculating a difference between the power level and a specified value; and
deciding that distortion is present if the difference exceeds a predetermined value;

3. The method of claim 2, wherein the determining further comprises deciding that distortion is absent if the difference is less than the predetermined value.

4. The method of claim 2, wherein the determining further comprises deciding that distortion is absent if the difference is less than or equal to the predetermined value.

5. The method of claim 1, wherein the amplifier linearity is adjusted by adjusting a bias voltage level for the amplifier.

6. The method of claim 1, wherein the increasing the amplifier's amplifier linearity comprises:
a) increasing bias voltage;
b) measuring distortion in the received signal;
c) determining if measured distortion is within specified limits; and
d) repeating a, b, and c if measured distortion exceeds specified limits.

7. The method of claim 6 further comprising after c) stopping if bias voltage is approximately equal to upper adjustment limit.

8. The method of claim 1, wherein the decreasing the amplifier's amplifier linearity comprises:
i) decreasing bias voltage;
ii) measuring distortion in the received signal;
iii) determining if distortion is present in the received signal;
iv) determining if distortion is within specified limits if there is distortion present in the received signal;
v) increasing bias voltage if distortion exceeds specified limits; and
vi) repeating i, ii, iii, iv, and v if distortion is absent from the received signal.

9. The method of claim 8 further comprising after v) stopping if bias voltage is approximately equal to lower adjustment limit.

10. The method of claim 1, wherein the determining, increasing, and decreasing are repeated.

11. The method of claim 1, wherein the determining, increasing, and decreasing are repeated after a specified period of time.

12. The method of claim 1, wherein the determining, increasing, and decreasing are repeated if a performance metric exceeds a predetermined value.

13. The method of claim 12, wherein the performance metric is the received signal's bit error rate (BER).

14. The method of claim 12, wherein the performance metric is the received signal's frame error rate (FER).

15. The method of claim 12, wherein the performance metric is the received signal's packet error rate (PER).

16. A circuit for use in distortion reduction comprising:
an automatic gain control (AGC) unit coupled to a digital data stream, the AGC containing circuitry to measure a power level of a signal carried in the digital data stream and to produce an amplifier gain compensation value; and
a distortion detection and compensation (DDC) unit coupled to the AGC, the DDC containing circuitry to determine the amount of distortion in the signal carried in the digital data stream and to produce a bias voltage compensation value.

17. The circuit of claim 16, wherein the AGC comprises:
a signal power measurement unit coupled to the digital data stream, the signal power measurement unit containing circuitry to measure the power level of the signal carried in the digital data stream;
an amplifier gain compensation unit coupled to the signal power measurement unit, the amplifier gain compensation unit containing circuitry to produce an amplifier gain compensation value.

18. The circuit of claim 17, wherein the signal power measurement unit comprises:
a noncoherent accumulator, the noncoherent accumulator containing circuitry to calculate a magnitude of the signal carried in the digital data stream; and
an integrate and dump unit coupled to the noncoherent accumulator, the integrate and dump unit containing circuitry to sum an output produced by the noncoherent accumulator and to produce a received signal power measurement.

19. The circuit of claim 17, wherein the amplifier gain compensation unit comprises:
a comparator having an input coupled to the signal power measurement unit, the comparator to compare a received signal power measurement with a pre-specified threshold; and
an integrator coupled to the comparator, the integrator to calculate an amplifier gain compensation value from an output of the comparator.

20. The circuit of claim 19, wherein the pre-specified threshold is a signal level set point.

21. The circuit of claim 16, wherein the DDC comprises:
a comparator coupled to the AGC, the comparator to compare a received signal power measurement with a predetermined threshold;
a distortion detect decision unit coupled to the comparator, the distortion detect decision unit containing circuit to determine if distortion is present on the signal carried in the digital data stream; and
an active device bias adjust generator coupled to the distortion detect decision unit, the active device bias adjust generator containing circuitry to calculate a bias voltage compensation from an output of the distortion detect decision unit.

22. The circuit of claim 21, wherein the active device bias adjust generator also contains circuitry to adjust the value of the predetermined threshold.

23. The circuit of claim 21, wherein the predetermined threshold is a distortion level set point.

24. A wireless receiver comprising:
a receiver chain coupled to a signal input, the receiver chain containing circuitry to amplify, filter, mix, and digitally convert a signal on the signal input;
an automatic gain control (AGC) unit coupled to the receiver chain, the AGC containing circuitry to measure a power level of the signal carried on a digital data stream produced by the receiver chain and to produce an amplifier gain compensation value; and
a distortion detection and compensation (DDC) unit coupled to the AGC, the DDC containing circuitry to determine the amount of distortion in the signal carried in the digital data stream and to produce a bias voltage compensation value.

25. The wireless receiver of claim 24, wherein the AGC comprises:
a signal power measurement unit coupled to the digital data stream, the signal power measurement unit containing circuitry to measure the power level of the signal carried in the digital data stream;
an amplifier gain compensation unit coupled to the signal power measurement unit, the amplifier gain compensation unit containing circuitry to produce an amplifier gain compensation value.

26. The wireless receiver of claim 25, wherein the amplifier gain compensation unit is coupled to a variable gain amplifier in the receiver chain and the amplifier gain compensation value adjusts a gain of the variable gain amplifier.

27. The wireless receiver of claim 24, wherein the DDC comprises:
a comparator coupled to the AGC, the comparator to compare a received signal power measurement with a predetermined threshold;
a distortion detect decision unit coupled to the comparator, the distortion detect decision unit containing circuit to determine if distortion is present on the signal carried in the digital data stream; and
an active device bias adjust generator coupled to the distortion detect decision unit, the active device bias adjust generator containing circuitry to calculate a bias voltage compensation from an output of the distortion detect decision unit.

28. The wireless receiver of claim 27, wherein the active device bias adjust generator is coupled to an amplifier in the receiver chain and the bias voltage compensation adjusts the linearity of the amplifier.

29. The wireless receiver of claim 24, wherein the wireless receiver is part of a wireless communications device operating in a wireless communications network.

30. The wireless receiver of claim 29, wherein the wireless communications network is a code-division multiple access (CDMA) wireless communications network.

31. The wireless receiver of claim 29, wherein the wireless receiver is part of a mobile station.

32. The wireless receiver of claim 29, wherein the wireless receiver is part of a base station.
